(19) United States
(12) Patent Application Publication
(10) Pub. No.: US 2011/0199897 A1
(43) Pub. Date: Aug. 18, 2011

(54) OVERLOAD CONTROL APPARATUS AND METHOD FOR USE IN RADIO COMMUNICATION SYSTEM

(75) Inventors: Sung Moon Shin, Daejeon (KR); Gyung Chul Shin, Daejeon (KR)

(73) Assignee: Electronics and Telecommunications Research Institute, Daejeon (KR)

(21) Appl. No.: 12/808,871

(22) PCT Filed: Sep. 11, 2008
(86) PCT No.: PCT/KR2008/005389

§ 371 Date: Jun. 17, 2010

(30) Foreign Application Priority Data
Dec. 17, 2007 (KR) 10-2007-0132803

(51) Int. Cl. H04W 28/02; H04W 24/00

(52) U.S. Cl. 370/230

(57) ABSTRACT

An overload control apparatus and method for use in a radio communication system are provided. According to the overload control apparatus and method, it is possible to efficiently manage the capacity of a radio communication system by determining whether the radio communication system is overloaded based on the intensity of a service request signal transmitted by a terminal and controlling the service request signal according to the results of the determination. Therefore, it is possible to stably operate a radio communication system.

### TECHNICAL FIELD

The present invention relates to an overload control apparatus and method for use in a radio communication system, and more particularly, to an overload control apparatus and method for use in a radio communication system, in which a radio communication system can be stably operated by controlling a service requested by a terminal according to the system capacity that can be allocated to the requested service.

The present invention was supported by the IT R&D program of Ministry of Information and Communication (MIC) and Institute for Information Technology Ad-vancement (IITA)[Project No. 2006-S-001-02, Project Title: Development of Adaptive Wireless Access and Transmission Technologies for Fourth-Generation Mobile Communication]

### BACKGROUND ART

Wideband code division multiple access (WCDMA) systems, which are next-generation mobile communication systems, use wider frequency bands than typical code division multiple access (CDMA) systems and can thus provide high processing gains and a high system capacity for the transmission of data. Since WCDMA can provide not only audio services but also other various services such as video services and can reduce the power consumption of terminals, WCDMA has been deemed one of the most efficient standards for providing next-generation mobile communication services.

In order to provide various multimedia services, including video services, it is required to improve the performance (including capacity) of a WCDMA system. More specifically, service providing rate and bit error rate vary according to the type of service requested by a user, and the intensity of a signal for providing a service varies according to service providing rate and bit error rate. Therefore, it is necessary to manage the capacity of a WCDMA system in consideration of the intensity of a service request signal for requesting a service.

In general, the load of a communication system is determined simply in consideration of system capacity used by a service requested by each terminal. However, if the load of a communication system is determined simply based on system capacity currently being used without considering the types of services requested by terminals, a communication service requiring a considerable amount of load may only be able to be provided to a few terminals, and a communication service requiring only a small amount of load may not be able to be provided to many terminals.

### DISCLOSURE OF INVENTION

### Technical Problem

The present invention provides an overload control apparatus and method for use in a radio communication system, in which a radio communication system can be stably operated by detecting in advance a signal requiring a considerable amount of system capacity based on the intensity of a service request signal transmitted by a terminal and determining whether to control a call based on service quantity that can be allocated to a service requested by the terminal.

### Technical Solution

According to an aspect of the present invention, there is provided an overload control apparatus for use in a wireless communication system, the overload control apparatus including a signal measurement unit which measures the intensity of a service request signal transmitted by a terminal; a first detection unit which receives the measured signal intensity and estimates system capacity that can be allocated to a service requested by the terminal; a second detection unit which receives the measured signal intensity and determines system capacity actually used by the service requested by the terminal; and a management unit which compares the estimated system capacity and the actually-used system capacity, determines whether the radio communication system is overloaded based on the result of the comparison, and performs overload control on the radio communication system.

According to another aspect of the present invention, there is provided an overload control method for use in a wireless communication system, the overload control method including measuring the intensity of a service request signal transmitted by a terminal; estimating system capacity that can be allocated to a service requested by the terminal based on the measured signal intensity; determining system capacity actually used by the service requested by the terminal based on the measured signal intensity; and comparing the estimated system capacity and the actually-used system capacity, determining whether the radio communication system is overloaded based on the result of the comparison, and performing overload control on the radio communication system.

### Advantageous Effects

According to the present invention, it is possible to efficiently manage the capacity of a radio communication system and thus to stably operate the radio communication system by determining whether the radio communication system is overloaded based on the intensity of a service request signal transmitted by a terminal and controlling the service request signal according to the result of the determination.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a schematic diagram of a radio communication system to which the present invention can be applied;

FIG. 2 illustrates a block diagram of an overload control apparatus for use in a radio communication system, according to an embodiment of the present invention; and

FIG. 3 illustrates a flowchart of an overload control method for use in a radio communication system, according to an embodiment of the present invention.

### BEST MODE FOR CARRYING OUT THE INVENTION

The present invention will hereinafter be described in detail with reference to the accompanying drawings in which exemplary embodiments of the invention are shown.

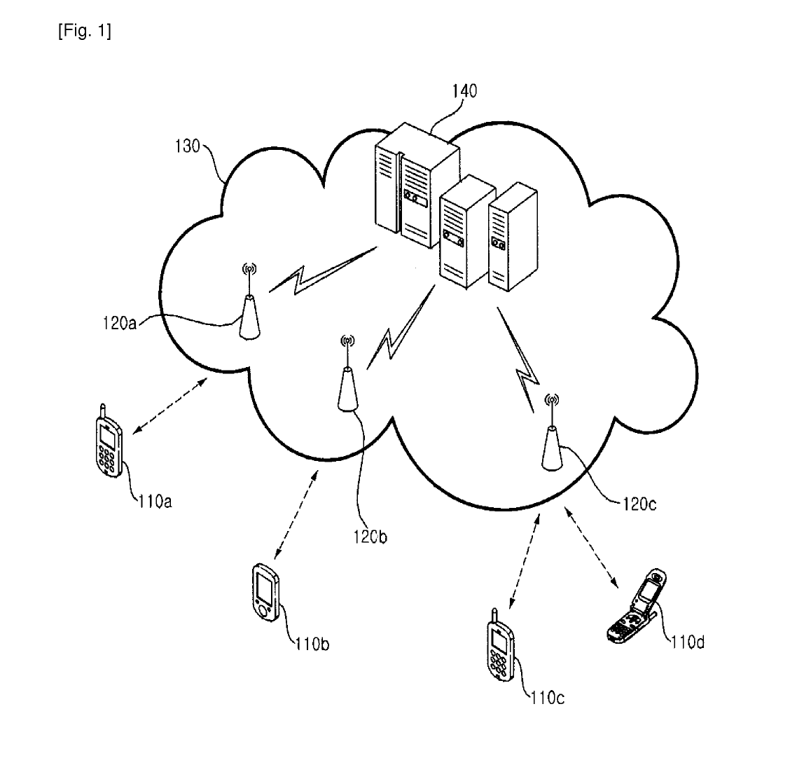

FIG. 1 illustrates a schematic diagram of a schematic diagram of a radio communication system to which the present invention can be applied. Referring to FIG. 1, the radio communication system includes a plurality of terminals 110a through 110d, which can be provided with communication services, a plurality of base stations 120a through 120c, which are connected to the terminals 110a through 110d, a communication network 130, and an overload control apparatus 140, which controls the operation of the base stations 120a through 120c. The communication network 130 may be a wideband code division multiple access (WCDMA) network. The terminals 110a through 110d will hereinafter be collectively referred to as the terminals 110, and the base stations 120a through 120c will hereinafter be collectively referred to as the base stations 120.

The terminals 110 may be mobile nodes (MNs) which are connected to the communication network 130 and can thus be provided with communication services through the communication network 130. The terminals 110 may be personal digital assistants (PDAs), mobile communication terminals, or smart phones. Each of the terminals 110 may include at least one communication unit which transmits communication signals. The communication units of the terminals 110 may transmit/receive radio frequency (RF) signals and may thus connect the terminals 110 to the base stations 120.

The base stations 120 may be connected to the terminals 110, and may convert the format of signals transmitted between a mobile communication exchanger (not shown) and the terminals 110 to be suitable for a wireless link or a wired link. At least one base station 120 may be provided in a region where communication services are provided. The base stations 120 receive signals transmitted by the terminals 110 and transmit the received signals to the mobile communication exchanger.

The base stations 120 may divide radio waves to 120-, 60-, and 45-degree sector systems. A communication channel may be allocated to each of the sector systems according to the type of services. In this manner, it is possible to reduce radio interference that may occur in the base stations 120.

The communication network 130 may be a WCDMA network. The communication network 130 may include the base stations 120 connected to the terminals 110, a mobile communication exchanger connected to the base stations 120, and the overload control apparatus 140 managing the loads of the base stations 120.

The overload control apparatus 140 manages the loads of the base stations 120 by allowing or disallowing the transmission of service request signals transmitted by the terminals 110. More specifically, the overload control apparatus 140 may manage the loads of the base stations 120 by receiving service request signals transmitted by the terminals 110, measuring the intensities of the received service request signals, and identifying the types of services requested by the terminals 110 based on the results of the measurement.

A radio communication system may provide video services such as multimedia content services as well as voice services and text services. Video services require higher transmission rates and the transmission of signals with higher intensities, compared to voice services or text services. In addition, since the intensities of signals received by the base stations 120 regarding video services are generally high, video services are less affected by variations in the bandwidth of a radio communication system. Therefore, in order to effectively manage the loads of the base stations 120, various factors such as a transmission rate required for providing services, the intensity of signals and the influence of bandwidth variations may need to be considered.

The overload control apparatus 140 may manage the load of a radio communication system by setting in advance system capacity that can be allocated to a service requested by each of the terminals 110 and comparing the set system capacity with system capacity actually being used by the requested service. System capacity that can be allocated to a service may be determined in consideration of the influence of the service on a radio communication system.

For example, if a radio communication system provides a voice service having a signal-to-noise ratio (SNR) of 5 at a rate of 8 Kbps, provides a video service having an SNR of 10 at a rate of 32 Kbps and has a bandwidth of 5 MHz, the influence of the voice service on system capacity may be only half the influence of the video service on system capacity because the intensity of a signal necessary for providing a voice service is generally about four times higher than the intensity of a signal necessary for providing a video service due to the bandwidth of the radio communication system. If the radio communication system has a bandwidth of more than 5 MHz, the influence of the voice service on system capacity may be the same as the influence of the video service on system capacity.

Therefore, a radio communication system may manage the loads of the base stations 120 by comparing system capacity actually being used with estimated system capacity available for allocation. If system capacity currently being used accounts for at least 80% of total system capacity, it is determined that a radio communication system is overloaded. Then, a service that may considerably affect system capacity may be detected and blocked in advance while maintaining the system capacity currently being used at 80% or lower. In this manner, it is possible to prevent a radio communication system from being overloaded.

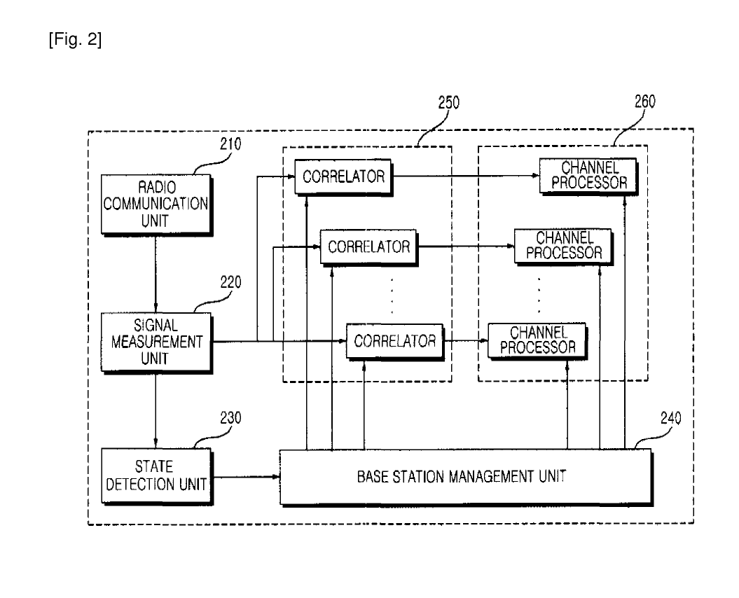

FIG. 2 illustrates a block diagram of the overload control apparatus 140 shown in FIG. 1. Referring to FIG. 2, the overload control apparatus 140 includes a radio communication unit 210, a signal measurement unit 220, a state detection unit 230, a base station management unit 240, a correlation unit 250 and a channel processing unit 260.

The radio communication unit 210 transmits/receives radio frequency (RF) signals. More specifically, the radio communication unit 210 receives a service request signal transmitted by a terminal 110 from a base station 120, and transmits a service provision signal corresponding to the service request signal to the terminal 110. The radio communication unit 210 may transmit/receive radio signals that comply with the WCDMA standard. The service request signal received by the radio communication unit 210 may be transmitted to the signal measurement unit 220.

The signal measurement unit 220 measures the intensity of a signal. More specifically, the signal measurement unit 220 measures the power of an RF signal provided by the radio communication unit 210. Since the intensity of a signal transmitted to the base station 120 by the terminal 110 varies according to the type of service requested by the terminal 110, the type of the service requested may be determined based on the result of the measurement performed by the signal measurement unit 220.

The state detection unit 230 determines system capacity necessary for providing the service requested by the terminal 110 based on the result of the measurement performed by the signal measurement unit 220. The state detection unit 230 stores system capacity information indicating system capacity that can be provided for the service requested by the terminal 110 by a radio communication system, for example, system capacity available for allocation to a service. For example, if the service requested by the terminal 110 is a video service, about 80% of the total capacity of the radio communication system may be allocated to the service requested by the terminal 110. On the other hand, if the service requested by the terminal 110 is an audio service, about 60% of the total capacity of the radio communication system may be allocated to the service requested by the terminal 110. If system capacity necessary for providing the service requested by the terminal 100 exceeds the allocated system capacity, the radio communication system may be placed in an overloaded state.

The state detection unit 230 may calculate system capacity using Equation (1):

MathFigure 1

$$C = {\sum }_{k} ( {r}_{k} \cdot {C}_{k} ) \qquad [ Math . 1 ]$$

where C indicates equivalent capacity by converting a service that can be provided by the radio communication system into a voice service, k indicates the service that can be provided by the radio communication system, rₖ indicates traffic of the service k, and more particularly, the intensity of a signal regarding the service k, and Cₖ indicates system capacity that can be allocated to the service k.

The traffic rₖ is proportional to service providing rate and signal-to-noise ratio (SNR) for satisfying bit error rate (BER). SNR is the ratio of the energy of a signal to the energy of noise included in the signal. As SNR increases, BER decreases.

The state detection unit 230 estimates system capacity available for allocation based on the system capacity calculated using Equation (1) and the service providing rate, the SNR, and the bandwidth of the radio communication system, and transmits the estimated system capacity to the base station management unit 240. More specifically, the state detection unit 230 may estimate the system capacity available for allocation in consideration of the intensity of a service request signal transmitted by each of the terminals 110 by using the service providing rate and the SNR of the radio communication system. The base station management unit 240 may determine whether the base stations 120 are overloaded based on the estimated system capacity provided by the state detection unit 230, and may manage the base stations 120 according to the results of the determination.

As described above, service providing rate and SNR are proportional to the intensity of a service request signal received by each of the base stations 120. For example, when the radio communication system is overloaded, the intensity of a signal for providing a voice service is higher than the intensity of a signal for providing a video service. Thus, an overload level for a voice service may be set higher than an overload level for a video service. The base station management unit 240 receives the estimated system capacity calculated by the state detection unit 230, sets an overload level for a service provided to each of the terminals 110, and controls a service request signal corresponding to a high overload level, thereby preventing the radio communication system from being overloaded.

The base station management unit 240 calculates system capacity actually being used by each service, compares the actually-used system capacity with estimated system capacity available for allocation, and determines whether the base stations 240 are overloaded based on the results of the comparison. The state detection unit 230 may calculate the actually-used system capacity. If the radio communication system is a WCDMA system and a voice service request signal and a video service request signal are both received when the radio communication system is yet to be overloaded, the voice service request signal may be controlled because a voice service generally has a higher overload level than that of a video service. In this manner, it is possible to prevent a WCDMA system from being overloaded.

Alternatively, the base station management unit 240 may notify the terminals 110 of system capacity actually used by each service and may thus stop the terminals 110 from issuing a service request any longer. The base station management unit 240 transmits actually-used system capacity periodically detected by the state detection unit 230 to all the terminals 110 in a cell managed by the base station management unit 240, and enables the terminals 110 to control the transmission of a service request signal according to the actually-used system capacity.

The correlation unit 250 modulates a high-frequency signal provided by the signal measurement unit 220 into a digital signal. The correlation unit 250 may be included in the radio communication system according to the type of service provided by the radio communication system. The correlation unit 250 is managed by the base station management unit 240. The base station management unit 240 controls the correlation unit 250 according to information provided by the state detection unit 230 regarding the state of the radio communication system.

More specifically, if a service requiring a considerable amount of system capacity is requested when the radio communication system is yet to be overloaded, the base station management unit 240 may stop the correlation unit 250 from modulating a high-frequency signal corresponding to the requested service into a digital signal and may thus control the operation of the channel processing unit 260, which receives a digital signal provided by the correlation unit 250 and provides a service corresponding to the received digital signal.

The channel processing unit 260 receives a digital signal provided by the correlation unit 250 and decodes the received digital signal on a channel-by-channel basis, thereby providing a service provided by each of the terminals 110. The channel processing unit 260 may be controlled by the base station management unit 240. Thus, when the radio communication system is overloaded, the channel processing unit 260 may be controlled either to provide or not to provide a service for a predetermined channel. For example, if a service requiring a considerable amount of system capacity is requested and thus the radio communication system is highly likely to be overloaded due to the provision of another service during the decoding of a digital signal by the channel processing unit 260, the base station management unit 240 may terminate the operation of the channel processing unit 260, and may thus prevent the radio communication system from being overloaded.

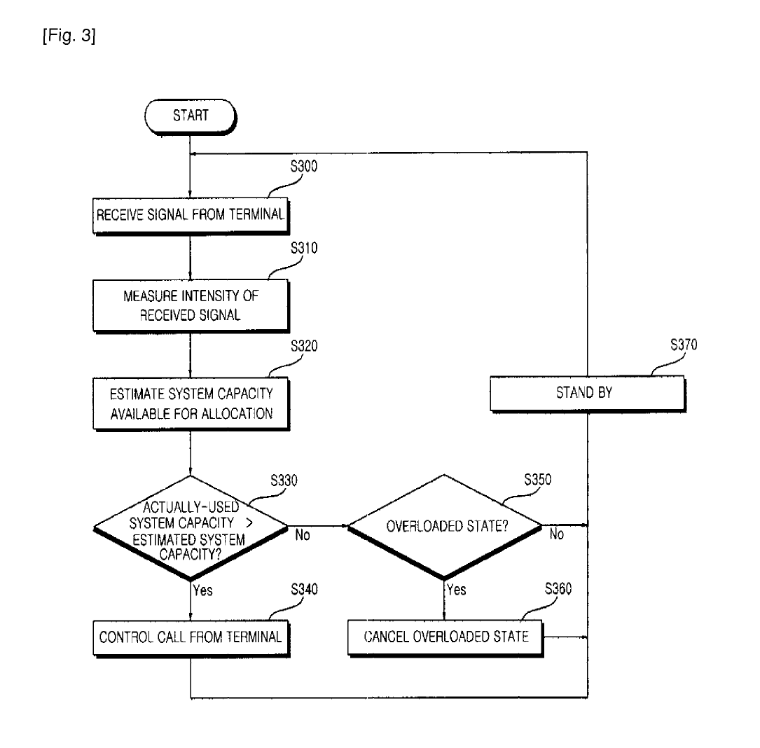

FIG. 3 illustrates a flowchart of an overload control method for use in a radio communication system, according to an embodiment of the present invention. Referring to FIG. 3, a radio communication system receives a service request signal from a terminal 110. The radio communication system may be a WCDMA system. The service request signal may be provided to the radio communication system through a base station 120.

The base station 120 transmits the service request signal to the load control apparatus 140 through the communication network 130. The load control apparatus 140 receives the service request signal via the radio communication unit 210 (S300), and transmits the service request signal to the signal measurement unit 220. The signal measurement unit 220 measures the intensity of the service request signal (S310).

The intensity of the service request signal may be measured in unit of power. The intensity of the service request signal may vary according to the type of service provided by the radio communication system. Thus, the type of service requested by the terminal 110 may be determined based on the intensity of the service request signal.

Once the type of service requested by the terminal 110 is determined based on the intensity of the service request signal, the state detection unit 230 estimates system capacity available for allocation (S320). For example, the state detection unit 230 may calculate remaining system capacity available for use in the radio communication system. The state detection unit 230 may estimate the system capacity available for allocation based on traffic caused by the service requested by the terminal 110 and system capacity that can be allocated to the service requested by the terminal 110.

For example, if the radio communication system is a WCDMA system providing a voice service having an SNR of 5 at a rate of 8 Kbps and providing a video service having an SNR of 10 at a rate of 32 Kbps, the influence of the voice service on the capacity of the radio communication system may be only half the influence of the video service on the capacity of the radio communication system. Since a voice service is more affected by the bandwidth of the radio communication system than a video service, a WCDMA system having a bandwidth of 5 MHz needs to transmit a signal whose intensity is four times greater the intensity of a signal transmitted by a CDMA system having a bandwidth of 1.25 in order to provide a voice service.

However, since there is a limit in the intensity of signals that can be transmitted by the terminal 110, the quality of voice services is likely to deteriorate when the radio communication system is overloaded. Thus, the radio communication system may be overloaded when a considerable number of terminals 110 request voice services at the same time. On the other hand, the intensity of a signal for providing a video service is relatively lower than the intensity of a signal for providing a voice service, and thus, the influence of a video service on the capacity of the radio communication system is less than the influence of a voice service on the capacity of the radio communication system. Therefore, the state detection unit 230 may estimate the system capacity available for allocation on a service-by-service basis.

The estimated system capacity is transmitted to the base station management unit 240. Then, the base station management unit 240 calculates system capacity actually being used, and compares the actually-used system capacity with the estimated system capacity provided by the state detection unit 230 (S330). For example, the radio communication system may be determined to be overloaded with a video service if 80% or more of the total capacity of the radio communication is currently being used for providing a video service. In addition, the radio communication system may be determined to be overloaded with a voice service if 60% or more of the total capacity of the radio communication is currently being used for providing a voice service. If the actually-used system capacity exceeds the estimated system capacity, the base station management unit 240 may determine that the radio communication system is overloaded.

More specifically, if the actually-used system capacity exceeds the estimated system capacity, the base station management unit 240 may control a call from the terminal 110 (S340) by controlling the operation of the correlation unit 250 or the operation of the channel processing unit 260. Alternatively, the base station management unit 240 may notify the terminal 110 that the radio communication system is overloaded, and may thus control the terminal 110 not to request any service. Once a call from the terminal 110 is controlled, the overload control apparatus 140 is placed in a standby mode and waits for the terminal 110 to transmit another service request signal (S370).

If the actually-used system capacity does not exceed the estimated system capacity, the base station management unit 240 may determine whether the radio communication system is overloaded with the requested service (S350). If the radio communication system is determined to be overloaded with the requested service, the base station management unit 240 may release the radio communication system from an overloaded state (S360), and the overload control apparatus 140 may wait for the terminal to transmit a service request signal (S370). On the other hand, if the radio communication system is determined yet to be overloaded with the requested service, the overload control apparatus 140 may wait for the terminal to transmit a service request signal (S370).

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

### INDUSTRIAL APPLICABILITY

According to the present invention, it is possible to efficiently manage the capacity of a radio communication system and thus to stably operate the radio communication system by determining whether the radio communication system is overloaded based on the intensity of a service request signal transmitted by a terminal and controlling the service request signal according to the result of the determination.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An overload control apparatus for use in a wireless communication system, the overload control apparatus comprising:
a signal measurement unit which measures the intensity of a service request signal transmitted by a terminal;
a first detection unit which receives the measured signal intensity and estimates system capacity that can be allocated to a service requested by the terminal;
a second detection unit which receives the measured signal intensity and determines system capacity actually used by the service requested by the terminal; and
a management unit which compares the estimated system capacity and the actually-used system capacity, determines whether the radio communication system is overloaded based on the result of the comparison, and performs overload control on the radio communication system.

2. The overload control apparatus of claim 1, wherein, if the actually-used system capacity exceeds than the estimated system capacity, the management unit controls a call from the terminal.

3. The overload control apparatus of claim 1, wherein the management unit transmits the actually-used system capacity to the terminal and enables the terminal to control the service request signal.

4. The overload control apparatus of claim 1, wherein, if the actually-used system capacity does not exceed the estimated system capacity, the management unit determines whether the radio communication system is overloaded, and releases the radio communication system from an overloaded state if the radio communication system is determined to be overloaded.

5. The overload control apparatus of claim 1, wherein, if the actually-used system capacity does not exceed the estimated system capacity, the management unit determines whether the radio communication system is overloaded, and waits for the terminal to transmit another service request signal if the radio communication system is determined yet to be overloaded.

6. The overload control apparatus of claim 1, further comprising:
a correlation unit which modulates the service request signal into a digital signal; and
a channel processing unit which decodes the digital signal for each channel.

7. The overload control apparatus of claim 6, wherein the management unit performs overload control on the radio communication system by managing the correlation unit and the channel processing unit.

8. The overload control apparatus of claim 1, wherein the first detection unit determines the estimated system capacity in consideration of at least one of the total capacity, the service providing rate, the signal-to-noise ratio (SNR) and the bandwidth of the radio communication system.

9. An overload control method for use in a wireless communication system, the overload control method comprising:
measuring the intensity of a service request signal transmitted by a terminal;
estimating system capacity that can be allocated to a service requested by the terminal based on the measured signal intensity;
determining system capacity actually used by the service requested by the terminal based on the measured signal intensity; and
comparing the estimated system capacity and the actually-used system capacity, determining whether the radio communication system is overloaded based on the result of the comparison, and performing overload control on the radio communication system.

10. The overload control method of claim 9, wherein the performing overload control, comprises controlling a call from the terminal if the actually-used system capacity exceeds the estimated system capacity.

11. The overload control method of claim 9, wherein the performing overload control, comprises transmitting the actually-used system capacity to the terminal and enabling the terminal to control the service request signal.

12. The overload control method of claim 9, wherein the performing overload control, comprises, if the actually-used system capacity does not exceed the estimated system capacity, determining whether the radio communication system is overloaded and releasing the radio communication system from an overloaded state if the radio communication system is determined to be overloaded.

13. The overload control method of claim 9, wherein the performing overload control, comprises, if the actually-used system capacity does not exceed the estimated system capacity, determining whether the radio communication system is overloaded, and waiting for the terminal to transmit another service request signal if the radio communication system is determined yet to be overloaded.

14. The overload control method of claim 9, further comprising:
modulating the service request signal into a digital signal; and
decoding the digital signal for each channel.

15. The overload control method of claim 14, wherein the performing overload control, comprises managing the modulating and the decoding.

16. The overload control method of claim 9, wherein the estimating the system capacity that can be allocated to a service requested by the terminal in consideration of at least one of the total capacity, the service providing rate, the SNR and the bandwidth of the radio communication system.
